(19) United States
(12) Patent Application Publication
(10) Pub. No.: US 2009/0091564 A1
(43) Pub. Date: Apr. 9, 2009

(54) SYSTEM AND METHOD FOR RENDERING ELECTRONIC DOCUMENTS HAVING OVERLAPPING PRIMITIVES

(76) Inventor: Thevan Raju, Carlingford (AU)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/866,803

(22) Filed: Oct. 3, 2007

(51) Int. Cl. G06T 15/00

(52) U.S. Cl. 345/419

(57) ABSTRACT

The subject application is directed to a system and method for document rendering. Scanline memory locations are first allocated by a memory allocation unit corresponding to a scanline of an electronic document to be rendered. Instruction memory locations are then allocated for each scanline memory location. An electronic document having at least one output primitive is then received and a unique identifier is assigned to each of the primitives. Each output primitive is then converted into a series of instructions, associated with one or more scanline memory locations. Each instruction is then stored in an allocated instruction memory location corresponding to a selected scanline memory location. An encoded scanline output file, including content of each instruction memory location corresponding to each scanline memory location, is communicated to an associated document rendering device. Each primitive is then rendered according to an output priority based upon identifiers associated with the primitives.

### BACKGROUND OF THE INVENTION

The subject application is directed generally to the field of rendering bitmapped images from encoded descriptions of electronic document files, and more particularly to efficient rendering of complex electronic documents formed of multiple, overlapping primitives.

A typical document output device, such as a laser printer, inkjet printer, or other bitmapped output device typically generates a bitmapped output image from rendering completed by raster image processing (“RIP”). A higher level description language is typically associated with an electronic document. This is often referred to as a page description language or PDL. There are many page description language formats. They may emanate from an application, such as a word processing package, drawing package, computer aided design (“CAD”) package, image processing package, or the like. Such files may also emanate from document inputs, such as electronic mail, scanners, digitizers, rasterizers, vector generators, data storage, and the like.

Common image files will include various primitives, such as geometric shapes or other defined areas, which primitives are encoded into the file in their entirety, even though one or more portions may be obscured by overlap with one or more of the remaining primitives.

A raster image processor typically decodes a higher level description language into a series of scanlines or bitmap portions that are communicated to a bitmapped output such as noted above. While an entire sheet (or more) of bitmapped image data is suitably prepared at one time into a page buffer and subsequently communicated to an engine, this requires a substantial amount of memory. Earlier raster image processors would therefore employ a scheme by which one band of pixels were extracted at a time from a page description, and this band would be buffered and communicated to an engine for generation of graphical output. A series of bands were thus generated and output to complete one or more pages of output.

It is often difficult to extract accurate band information, particularly when an input page description includes multiple images or mixed data types, such as graphics, text, overlays, and the like. In some earlier systems, generation of bands directly from a higher level, page description also requires that conversion to bands be completed at a timing that corresponds to a rate at which input is expected by a downstream engine.

Earlier improvements to rendering is defined in U.S. patent application Ser. No. 11/376,797 entitled SYSTEM AND METHOD FOR DOCUMENT RENDERING EMPLOYING BIT-BAND INSTRUCTIONS, filed Mar. 16, 2006, the content of which is incorporated herein by reference. Such improvements addressed many of the shortcomings of earlier rendering systems by employing encoded scanlines, without specific focus on additional concerns realized by overlapping primitives in encoded image files.

### SUMMARY OF THE INVENTION

In accordance with one embodiment of the subject application, there is provided a system and method directed to rendering bitmapped images from encoded descriptions of electronic document files.

Further, in accordance with one embodiment of the subject application, there is provided a system and method for efficient rendering of complex electronic documents formed of multiple, overlapping primitives.

Still further, in accordance with one embodiment of the subject application, there is provided a system for document rendering. The system comprises a memory allocation unit which includes scanline memory allocation means adapted for allocating a plurality of scanline memory locations, each scanline memory location corresponding to a scanline of a document to be rendered, and instruction memory allocation means adapted for allocating at least one instruction memory location corresponding to each scanline memory location. The system also comprises receiving means adapted for receiving an electronic document inclusive of at least one encoded visual output primitive and means adapted for assigning a unique identifier to each received visual output primitive. The system further comprises conversion means adapted for converting each visual output primitive of a received electronic document into a series of instructions, association means adapted for associating each instruction with at least one scanline memory location, and storage means adapted for storing each instruction in an instruction memory location allocated by the memory allocation unit and corresponding to a selected scanline memory location. The system also includes output means adapted for communicating an encoded scanline output file, inclusive of content of each instruction memory location corresponding to each scanline memory location, to an associated document rendering device, wherein each output primitive is rendered in accordance visual output priority corresponding to relative identifiers associated therewith.

In one embodiment of the subject application, the system also comprises means adapted for receiving the encoded scanline output file and decoding means adapted for sequentially decoding instructions of each scanline memory location. In this embodiment, the system further includes means adapted for generating a bitmap band output corresponding to decoded instructions of each scanline memory location such with a visual out for overlapping primitives is selected in accordance with relative identifiers associated with each.

In another embodiment of the subject application, each instruction specifies at least one of color, opacity, pattern, pixel range, and raster operation code.

In yet another embodiment of the subject application, the receiving means includes means adapted for receiving the electronic document inclusive of a plurality of encoded visual output primitives, such that at least one scanline memory location includes instructions corresponding to each of the plurality of encoded visual output primitives.

In a further embodiment, the decoding means decodes instructions from the at least one scanline memory location inclusive of instructions corresponding to each of the plurality of encoded visual output primitives, such that a decoded instruction generates a bitmap selectively overwrites at least a portion of that associated with a prior decoded instruction.

In still another embodiment, at least one instruction includes a raster operation code inclusive of at least of text rendering, general band rendering, graphics rendering, batch rendering, and caching.

Still further, in accordance with one embodiment of the subject application, there is provided a method for document rendering in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for document rendering according to one embodiment of the subject application;

FIG. 2 is a block diagram illustrating device hardware for use in the system for document rendering according to one embodiment of the subject application;

FIG. 3 is a functional diagram illustrating the device for use in the system for document rendering according to one embodiment of the subject application;

FIG. 4 is a block diagram illustrating controller hardware for use in the system for document rendering according to one embodiment of the subject application;

FIG. 5 is a functional diagram illustrating the controller for use in the system for document rendering according to one embodiment of the subject application;

FIG. 6 is an example page depicting visual output primitives for use in the system for document rendering according to one embodiment of the subject application;

FIG. 7 is an example of a visual output primitive for use in the system for document rendering according to one embodiment of the subject application;

FIG. 8 is an example of visual output primitive information for use in the system for document rendering according to one embodiment of the subject application;

FIG. 9 is a tabular scanline representation of a first visual output primitive of FIG. 6 for use in the system for document rendering according to one embodiment of the subject application;

FIG. 10 is a tabular scanline representation of a second visual output primitive of FIG. 6 for use in the system for document rendering according to one embodiment of the subject application;

FIG. 11 is a tabular scanline representation of a third visual output primitive of FIG. 6 for use in the system for document rendering according to one embodiment of the subject application;

FIG. 12 is a tabular scanline representation of a fourth visual output primitive of FIG. 6 for use in the system for document rendering according to one embodiment of the subject application;

FIG. 13 is an example object list corresponding to FIG. 6 for use in the system for document rendering according to one embodiment of the subject application;

FIG. 14 is an example object list corresponding to FIG. 6 for use in the system for document rendering according to one embodiment of the subject application;

FIG. 15 is an example object list corresponding to FIG. 6 for use in the system for document rendering according to one embodiment of the subject application;

FIG. 16 is an example object list corresponding to FIG. 6 for use in the system for document rendering according to one embodiment of the subject application;

FIG. 17 is an example object list corresponding to FIG. 6 for use in the system for document rendering according to one embodiment of the subject application;

FIG. 18 is an example object list corresponding to FIG. 6 for use in the system for document rendering according to one embodiment of the subject application;

FIG. 19 is an example object list corresponding to FIG. 6 for use in the system for document rendering according to one embodiment of the subject application;

FIG. 20 is an example object list corresponding to FIG. 6 for use in the system for document rendering according to one embodiment of the subject application;

FIG. 21 is a flowchart illustrating a method for document rendering according to one embodiment of the subject application; and

FIG. 22 is a flowchart illustrating a method for document rendering according to one embodiment of the subject application.

### DETAILED DESCRIPTION OF THE PREFERRED EMBODIMENT

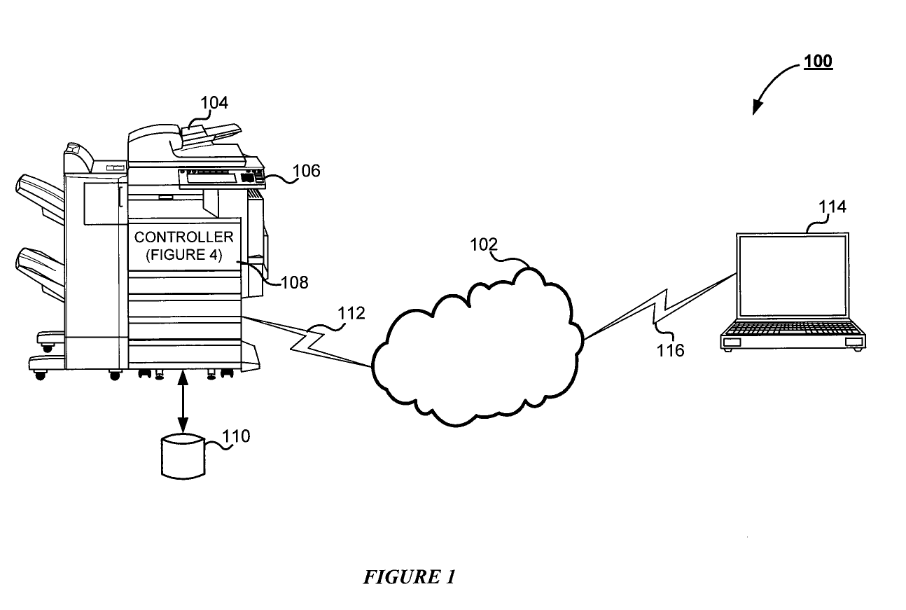

The subject application is directed to a system and method directed to rendering bitmapped images from encoded descriptions of electronic document files. In particular, the subject application is directed to a system and method for efficient rendering of complex electronic documents formed of multiple, overlapping primitives. More particularly, the subject application is directed to a system and method for document rendering. It will become apparent to those skilled in the art that the system and method described herein are suitably adapted to a plurality of varying electronic fields employing ordered instruction sequencing, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for document rendering in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

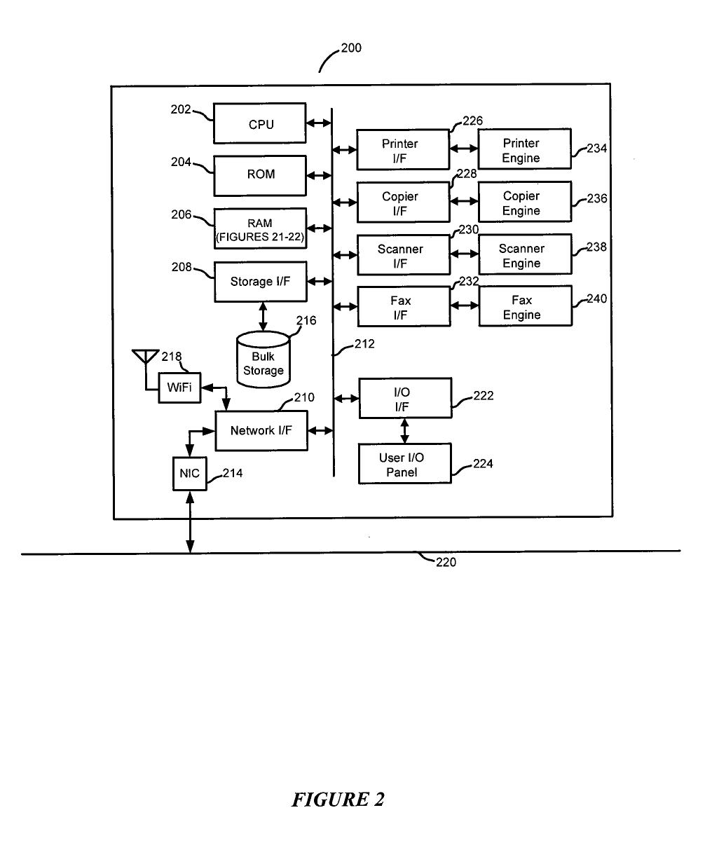

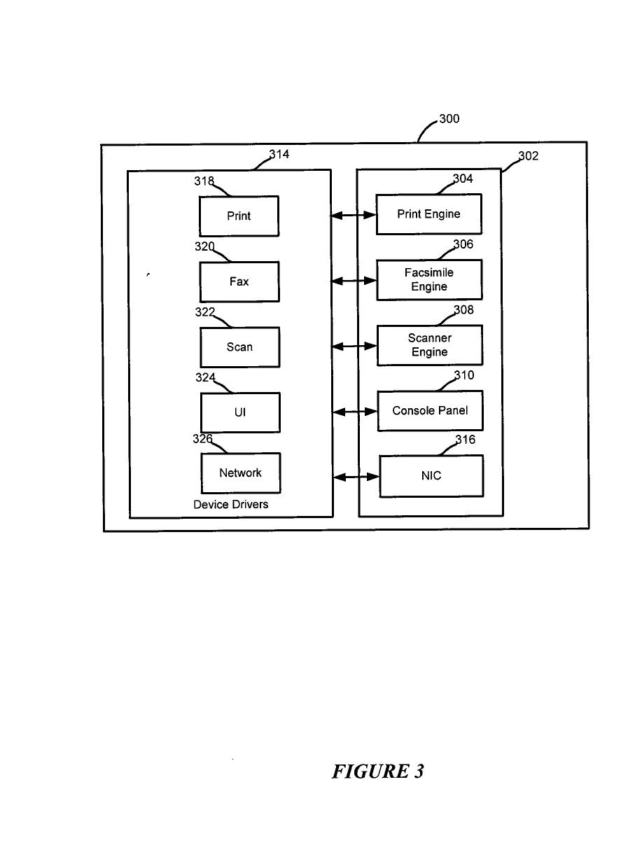

The system 100 also includes a document rendering device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document rendering devices include, for example and without limitation, the Toshiba e-Studio Series Controller. In accordance with one aspect of the subject application, the document rendering device 104 is suitably adapted to provide remote document processing services to external or network devices. Preferably, the document rendering device 104 includes hardware, software, and any suitable combination thereof, configured to interact with an associated user, a networked device, or the like. The functioning of the document rendering device 104 will better be understood in conjunction with the block diagrams illustrated in FIGS. 2 and 3, explained in greater detail below.

According to one embodiment of the subject application, the document rendering device 104 is suitably equipped to receive a plurality of portable storage media, including, without limitation, Firewire drive, USB drive, SD, MMC, XD, Compact Flash, Memory Stick, and the like. In the preferred embodiment of the subject application, the document rendering device 104 further includes an associated user interface 106, such as a touch-screen, LCD display, touch-panel, alpha-numeric keypad, or the like, via which an associated user is able to interact directly with the document rendering device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document rendering device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

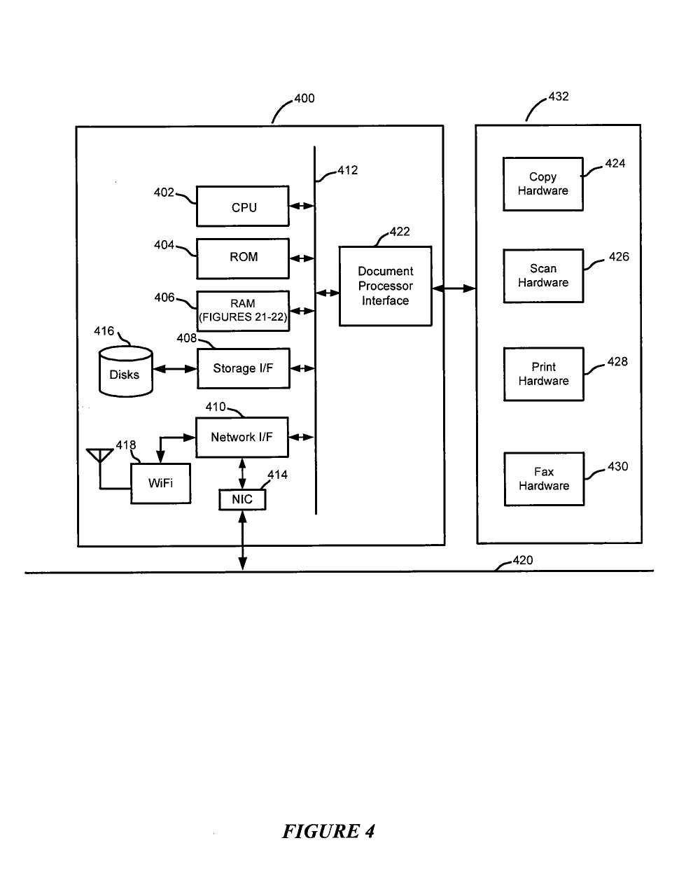

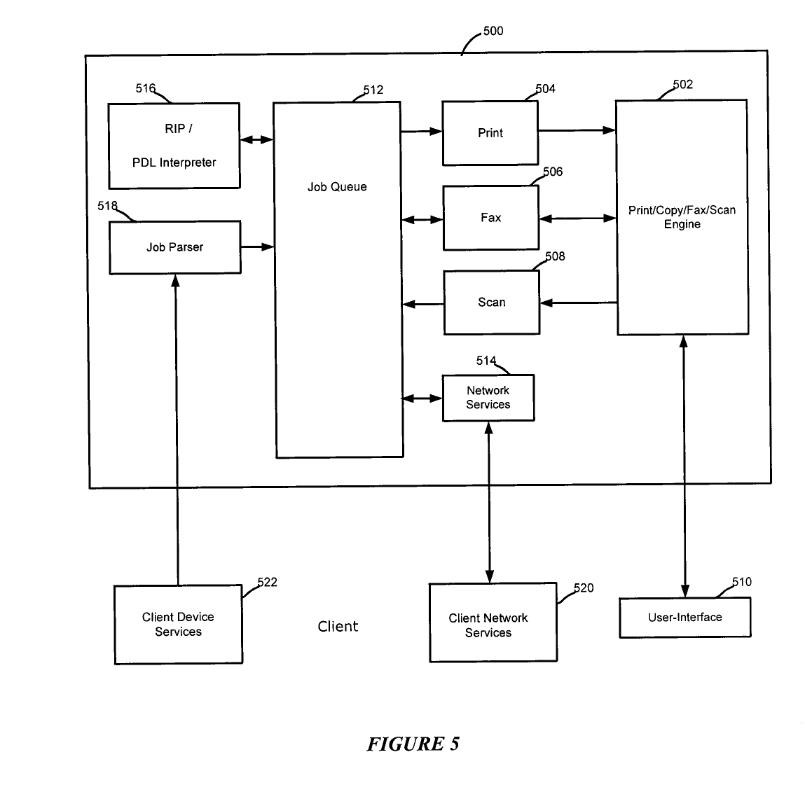

In accordance with one embodiment of the subject application, the document rendering device 104 further incorporates a backend component, designated as the controller 108, suitably adapted to facilitate the operations of the document rendering device 104, as will be understood by those skilled in the art. Preferably, the controller 108 is embodied as hardware, software, or any suitable combination thereof, configured to control the operations of the associated document rendering device 104, facilitate the display of images via the user interface 106, direct the manipulation of electronic image data, and the like. For purposes of explanation, the controller 108 is used to refer to any myriad of components associated with the document rendering device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and are intended as such when used hereinafter. Furthermore, the use of the controller 108 hereinafter is for the example embodiment only, and other embodiments, which will be apparent to one skilled in the art, are capable of employing the system and method for document rendering of the subject application. The functioning of the controller 108 will better be understood in conjunction with the block diagrams illustrated in FIGS. 4 and 5, explained in greater detail below.

Communicatively coupled to the document rendering device 104 is a data storage device 110. In accordance with the preferred embodiment of the subject application, the data storage device 110 is any mass storage devices known in the art including, for example and without limitation, magnetic storage drives, a hard disk drive, optical storage devices, flash memory devices, or any suitable combination thereof. In the preferred embodiment, the data storage device 110 is suitably adapted to store document data, image data, electronic database data, or the like. It will be appreciated by those skilled in the art that while illustrated in FIG. 1 as being a separate component of the system 100, the data storage device 110 is capable of being implemented as an internal storage component of the associated document rendering device 104, a component of the controller 108, or the like, such as, for example and without limitation, an internal hard disk drive, or the like. In accordance with one embodiment of the subject application, the data storage device 110 is capable of storing images, gift card formats, fonts, and the like.

The system 100 illustrated in FIG. 1 further depicts a user device 114, in data communication with the computer network 102 via a communications link 116. It will be appreciated by those skilled in the art that the user device 114 is shown in FIG. 1 as a laptop computer for illustration purposes only. As will be understood by those skilled in the art, the user device 114 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, user interface modifications, upgrades, updates, personalization data, or the like, to the document rendering device 104, or any other similar device coupled to the computer network 102. In accordance with one embodiment of the subject application, the user device 114 includes a web browser application, suitably adapted to securely interact with the document rendering device 104, or the like.

Turning now to FIG. 2, illustrated is a representative architecture of a suitable device 200, (shown in FIG. 1 as the document rendering device 104), on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document rendering devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document rendering device, (shown in FIG. 1 as the document rendering device 104), for use in connection with the disclosed system. FIG. 3 illustrates suitable functionality of the hardware of FIG. 2 in connection with software and operating system functionality as will be appreciated by one of ordinary skill in the art. The document rendering device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 108 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with bus the 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document rendering device, such as the document rendering device 104, which include the controller 400 of FIG. 4, (shown in FIG. 1 as the controller 108) as an intelligent subsystem associated with a document rendering device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document rendering devices that are subset of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

In operation, a plurality of scanline memory locations is first allocated by an associated memory allocation unit, with each scanline memory location corresponding to a scanline of an electronic document to be rendered. At least one instruction memory location is then allocated corresponding to each scanline memory location in the memory allocation unit. An electronic document, inclusive of at least one encoded visual output primitive, is then received and a unique identifier is assigned to each of the received encoded visual output primitive. Each of the visual output primitives of the received electronic document are then converted into a series of instructions, with each instruction thereafter associated with at least one scanline memory location. Each instruction is then stored in an instruction memory location allocated by the memory allocation unit corresponding to a selected scanline memory location. An encoded scanline output file, including content of each instruction memory location corresponding to each scanline memory location, is then communicated to an associated document rendering device. Thereafter, each visual output primitive is rendered according to a visual output priority based upon the relative identifiers associated with the primitives.

In accordance with one example embodiment of the subject application, a controller 108 or other suitable component associated with document rendering device 104, allocates scanline memory locations via a memory allocation unit. Preferably, each scanline memory location corresponds to a scanline of a document to be rendered. It will be appreciated by those skilled in the art that the memory is capable of comprising system memory associated with the document rendering device 104, virtual memory located on the data storage device 110, or any suitable combination thereof. The memory allocation unit, resident on the controller 108 or other suitable component associated with the document rendering device 104 then allocates at least one instruction memory location corresponding to each of the scanline memory locations.

Upon the receipt of an electronic document from the user device 114, operations of the document rendering device 104, e.g., facsimile receipt, scanning, copying, or the like, electronic mail transmission, or other suitable means of receiving an electronic document for further processing by the document rendering device 104, a determination is made whether the electronic document includes one or more visual output primitive components. As will be appreciated by those skilled in the art, a visual output primitive includes, for example and without limitation, points, lines, polygons, and the like. Suitable example visual output primitives include trapezoids, circles, triangles, squares, rectangles, spline curves, planes, and the like. When no primitive objects are detected by the controller 108 or other suitable component associated with the document rendering device 104, the received electronic document data is converted into a series of instructions, with each instruction associated with at least one scanline memory location. The conversion of the electronic document data is explained in greater detail in U.S. patent application Ser. No. 11/376,797 entitled SYSTEM AND METHOD FOR DOCUMENT RENDERING EMPLOYING BIT-BAND INSTRUCTIONS, filed Mar. 16, 2006, as incorporated above.

When one or more visual output primitives are detected, each of the detected primitives is assigned a unique identifier. In accordance with one embodiment of the subject application, each primitive is assigned a unique object identification, such as an alphanumeric character, value, or the like. Each primitive is then converted into a series of instructions. Each of the instructions is then stored in an allocated instruction memory location corresponding to a selected scanline memory location. According to one embodiment of the subject application, each instruction specifies, for example and without limitation, color, opacity, pattern, pixel range, raster operation code, or the like. Suitable examples of such raster operation codes include, without limitation, text rendering, general band rendering, graphics rendering, batch rendering, caching, and the like.

An encoded scanline output file is then communicated to the document rendering device 104, e.g., from the controller 108 to the document rendering device 104, for further operations thereon. The skilled artisan will appreciate that the document rendering device 104 corresponds to any suitable component thereof capable of performing the operations described by the series of instructions associated with the electronic document. The encoded scanline output file is then received by the document rendering device 104. When primitives were detected in the received electronic document, the skilled artisan will appreciate that at least one scanline memory location includes instructions corresponding to each of the encoded visual output primitives. The document rendering device 104, or any suitable component thereof, then sequentially decodes the instructions from the scanline memory location.

A bitmap band output is then generated by the document rendering device 104 or a suitable component thereof corresponding to decoded instructions of each scanline memory location, such that a visual output for overlapping primitives, if present, is selected in accordance with the identifiers associated with each primitive. The skilled artisan will appreciate that when primitives are present in the received electronic document, the sequential decoding corresponds to each of the plurality of encoded visual output primitives such that a decoded instruction generates a bitmap that selectively overwrites at least a portion of that associated with a prior decoded instruction.

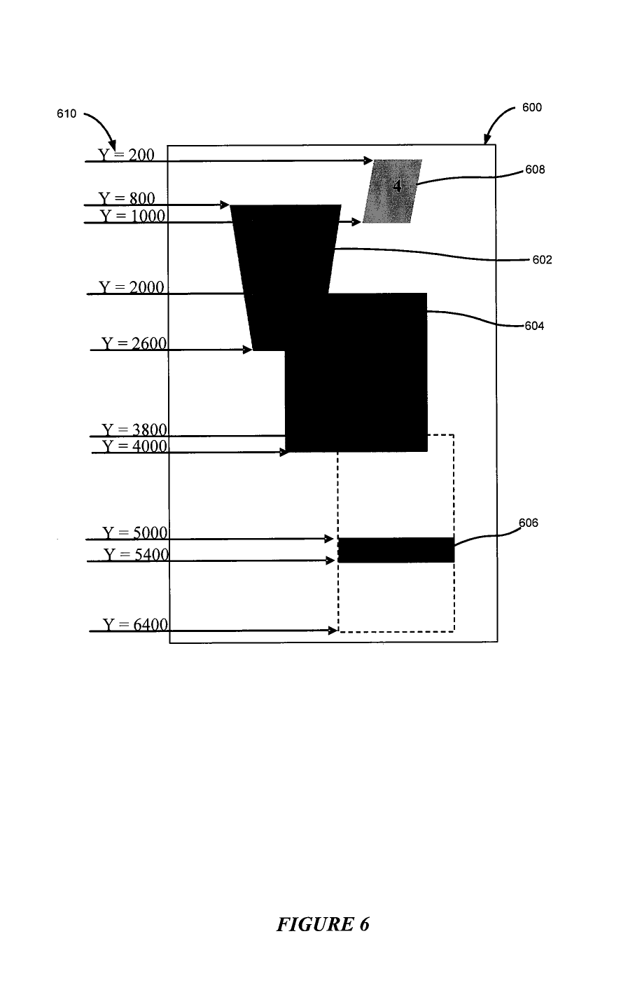

The foregoing will be better understood in conjunction with an additional example embodiment corresponding to the processing of the image represented in FIG. 6 in accordance with the subject application for document rendering. Shown in FIG. 6 are four objects, Object 1 (602), Object 2 (604), Object 3 (606), and Object 4 (608), which are printed on the current page 600. The skilled artisan will appreciate that the Objects 602-608 suitable represent visual output primitives of the image 600 of FIG. 6. The numbers on each object 602-608 represent the order in which the objects are presented to the raster image processor during the current print job. The scanline numbers 610 are depicted on the left-side of the page 600. The dashed line for Object 3 (606) represents the size of the Object 606, however, with a clip path corresponding to Y=5000 and Y=5400, resulting in Object 3 (606) being printed on the page 600 only within scanlines 5000 and 5400.

The first step in processing the page 600 of FIG. 6 occurs when the raster image processor, associated with the controller 108, document rendering device 104, or any suitable component thereof, is ready to begin a new page. The disk input/output and memory subsystems are then initialized and a scanline array is allocated and initialized, including scanline graphics states, to default, empty values.

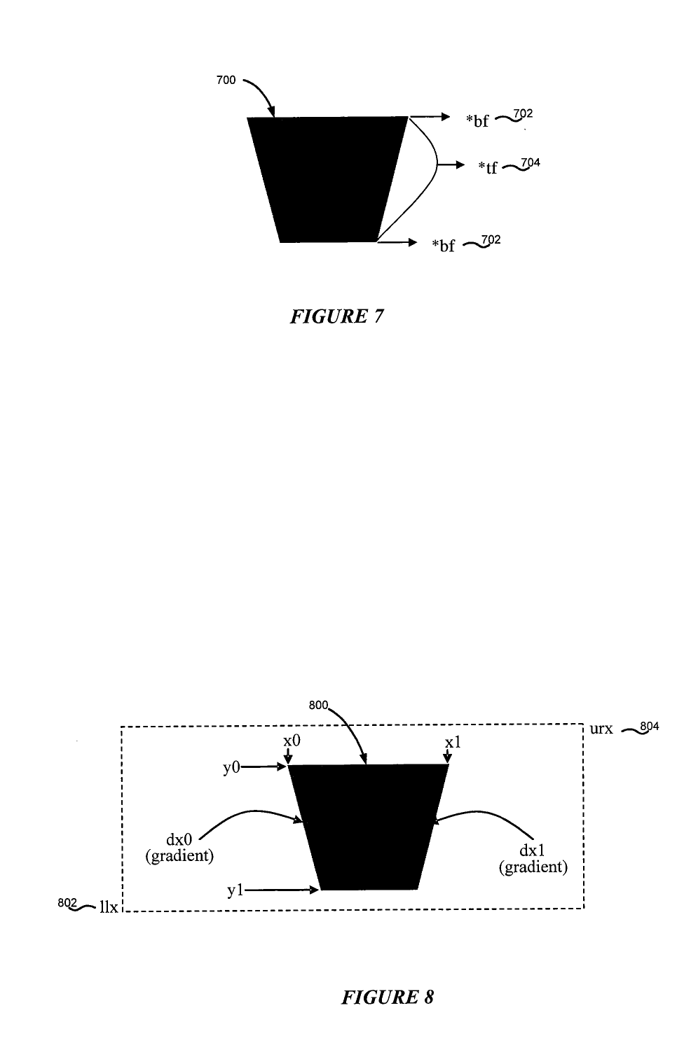

The first object 602, shown in FIG. 7 as the trapezoid 700, is then parsed by a parser associated with the controller 108 or other suitable component associated with the document rendering device 104, and converted to the device space by the color system and the scan conversion mechanisms associated with the controller 108 or other suitable component associated with the document rendering device 104. The skilled artisan will appreciate that FIG. 7 depicts the trapezoid 700 (Object 1 (602) from FIG. 6) being rendered using band rendering functions (*bf) 702 and trapezoid rendering functions (*tf) 704. It will be appreciated by those skilled in the art that in accordance with one embodiment of the subject application, both band rendering function (*bf) 702 and the trapezoid rendering function (*tf) 704 are made available to the rendering engine. According to a further embodiment of the subject application, the trapezoid 700 is broken up into three segments, namely, the first scanline, the last scanline and all the scanlines in between. According to yet another embodiment, the number of scanlines in between the first and the last scanlines is then determined. If the determined number of scanlines is larger than a pre-determined threshold, the trapezoid 700 is broken into three segments, otherwise, the trapezoid 700 is broken into a number of segments that equals the total number of scanlines spanning the trapezoid 700. In accordance with one embodiment of the subject application, the pre-determined threshold is computed using the ratio of bytes consumed by the trapezoid representation to that consumed by the band representation, as will be appreciated by those skilled in the art.

In accordance with the example embodiment of the subject application, the data that makes up the trapezoid 700, or Object 1 (602), is a suitable software structure, e.g., _tPxSTrapezoid is used. A suitable example of the information contained in such a structure is depicted in FIG. 8, which includes Object 1 (602) as the trapezoid 800. If there is a clip path, the clipping bounds “lower left x” (i.e. llx 802) and “upper right x” (i.e. urx 804) are also stored. If there is no clipping, these bounds 802 and 804 represent the page bounds. In addition, the skilled artisan will appreciate that the structure includes two more members named lAdj and rAdj, which respectively correspond to left adjustment and right adjustment for each scanline. It will be understood by those skilled in the art that in accordance with POSTSCRIPT page description language (PostScript PDL), any pixel that is touched is painted, however, for PCLXL, the center of the pixel is in the middle, thus 0.5 pixel adjustments are necessary using the adjustment members, e.g., lAdj and rAdj.

In accordance with one embodiment of the subject application, each scanline stores simple graphics state information which is used both during the process of adding instructions to a scanline and also during the final rendering process. It contains:

Current color (default is black)

Current opacity (default is opaque)

Current Raster Operations operator (ROP operator) (default is rop0)

Current pattern (default is no pattern)

Depending on the current color, and the color of the current band to be inserted into the instructions list, either opRenderBand (5 bytes) or the opRenderBandColor (9 bytes), is used. If the color of the band is the same as the current color in the graphics state, the color of the current band is not included within the OpCode by using opRenderBand which saves 4 bytes. The above OpCodes apply to objects that are represented over a single scanline. If they span over multiple scanlines, the similar OpCodes opRenderTrap (31 bytes) and opRenderTrapColor (35 bytes) are used.

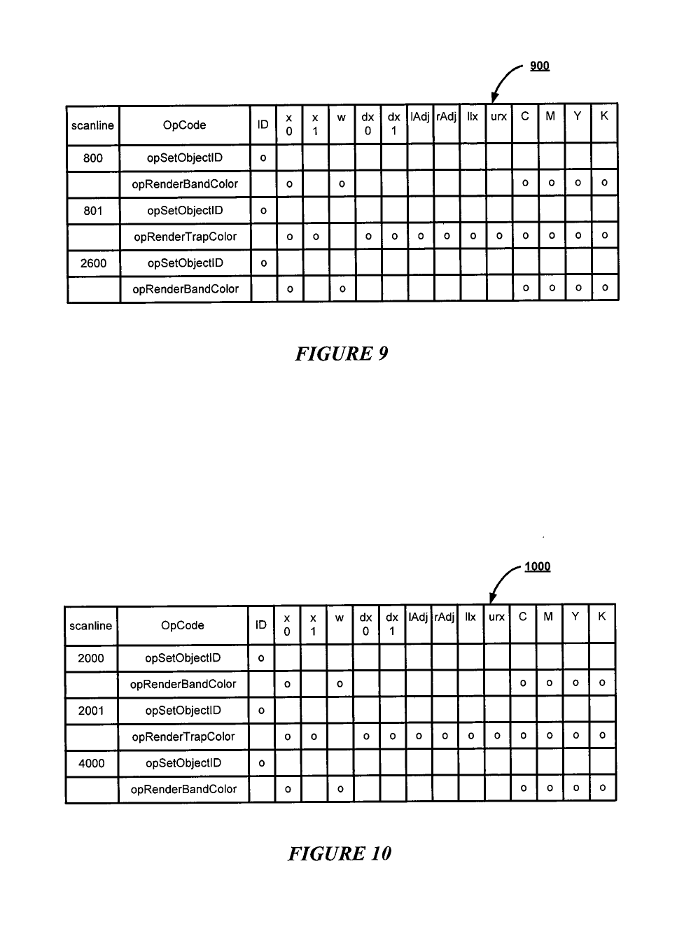

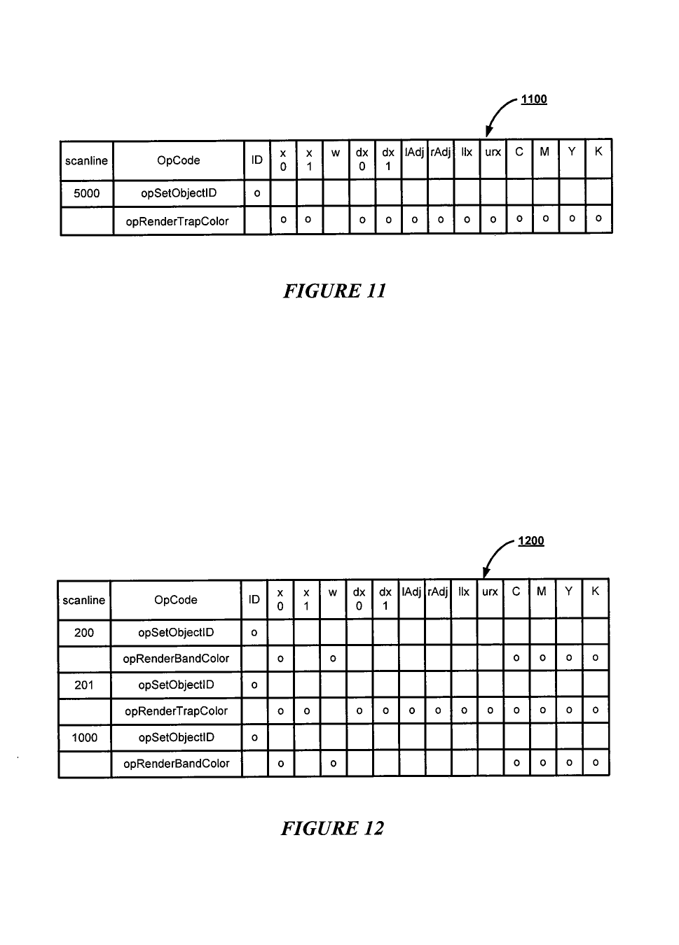

Considering the example given in FIG. 6, the first instruction encountered will be at scanline 800 for Object 1 (602). The first scanline of Object 1 (602) will be treated as a band. Since the color of the band (for example, red) is not the same as the default current color in the scanline graphics state (i.e. black), opRenderBandColor will be used. Accordingly, Object 1 (602) is represented by the scanline data in the table 900 given in FIG. 9. It should be noted that the objectID=0 will be set at the tPxSRepresentation structure. Similarly, the table 1000 of FIG. 10 represents the scanline data of Object 2 (604), the table 1100 of FIG. 11 represents the scanline data of Object 3 (606), and the table 1200 of FIG. 12 represents the scanline data of Object 4 (608).

As shown in FIG. 6 and represented in FIG. 11, Object 3 (606) represents a clipped primitive, or object. The vertical (Y) clipping is pre-performed prior to starting the methodology of the subject application. Thus, only the OpCodes shown in table 1100 of FIG. 11 are used, with llx and urx set in accordance with the clipping information. The skilled artisan will appreciate that while Object 4 (608) is depicted at the top of the page 600, it is received by the raster image processor as the last object and is therefore represented last with the OpCodes shown in table 1200 of FIG. 12.

It will be apparent to those skilled in the art that the only populated scanlines of FIG. 6 are thus 200, 201, 800, 801, 1000, 2000, 2001, 2600, 4000, and 5000 (i.e., only ten (10) scanlines). Thus, the subject application effectively optimizes the representation size of the image of FIG. 6.

Following the population of the tables 900-1200, as referenced above, by the raster image processor or other suitable component associated with the controller 108, the document rendering device 104, or the like, rendering of the final completed bands of page data is undertaken in accordance with the subject application. Preferably, the controller 108 or other suitable component associated with the document rendering device 104, e.g., the raster image processor, then provides, or allocates, enough memory, e.g., system memory, virtual memory on the data storage device 110, or the like, for a full uncompressed band, typically 128 scanlines in height. Filling such a band involves finding each regular scanline that belongs in the band, and “playing back” or decoding the OpCodes in the instruction blocks associated with the band.

Returning to the page 600 of FIG. 6, the first populated scanline 610 is Y=200. Object 4 (608) is the first to be rendered. Prior to the occurrence of any rendering, a dynamic object list is set up to represent z-buffer information. In accordance with the instant example, the set up of a suitable object list is accomplished via the start of a linked list of software structures named tPxSObject having the following members:

| | |
|---|---|
| unsigned char objType | /*“Trapezoid” for example */ |
| tPxsTrapezoid trap | /* contains all the trapezoid information |
| | shown in Figure 8 */ |
| unsigned int objID | /* object ID */ |
| unsigned char OpCode | /* OpCode of the instruction */ |
| unsigned char c, m, y, k | /* color values */ |
| unsigned int blackOverPrint | /* whether BOP is on */ |
| struct _tPxSObject *next | /* pointer to the next object */ |

At the beginning of this rendering, the linked list will contain no objects and thus have NULL values associated therewith. In order to access the linked list, a higher level data structure, e.g., _jPxSCacheOpCodeSource is defined in the reserved 2 MB memory. It contains the following members:

| | | |
|---|---|---|
| unsigned char | *mem | /* pointer to the head of 2MB memory */ |
| unsigned char | *currentPtr | /* pointer to current location in the memory */ |
| unsigned int | size | /* size of the memory available */ |
| unsigned int | availableSize | /* remaining memory size for growing the object list */ |
| tPxSObject | *objList | /* pointer to the head of the object list */ |
| tPxSObject | *curObjList | /* pointer to current object in the object list */ |
| tPxSObject | *prevObj | /* pointer to previous object in the object list */ |
| tPxSObject | *freeList | /* list of objects that are no longer used, therefore can |
| | | be reused */ |

| | | |
|---|---|---|
| unsigned int | *scanlineObjectCnt | /* number of objects so far rendered in the |
| | | scanline */ |

| | | |
|---|---|---|
| fPxSAllocFuncPtr | memAlloc | /* memory allocation function pointer */ |
| fPxSAllocFuncPtr | memFree | /* memory freeing function pointer */ |

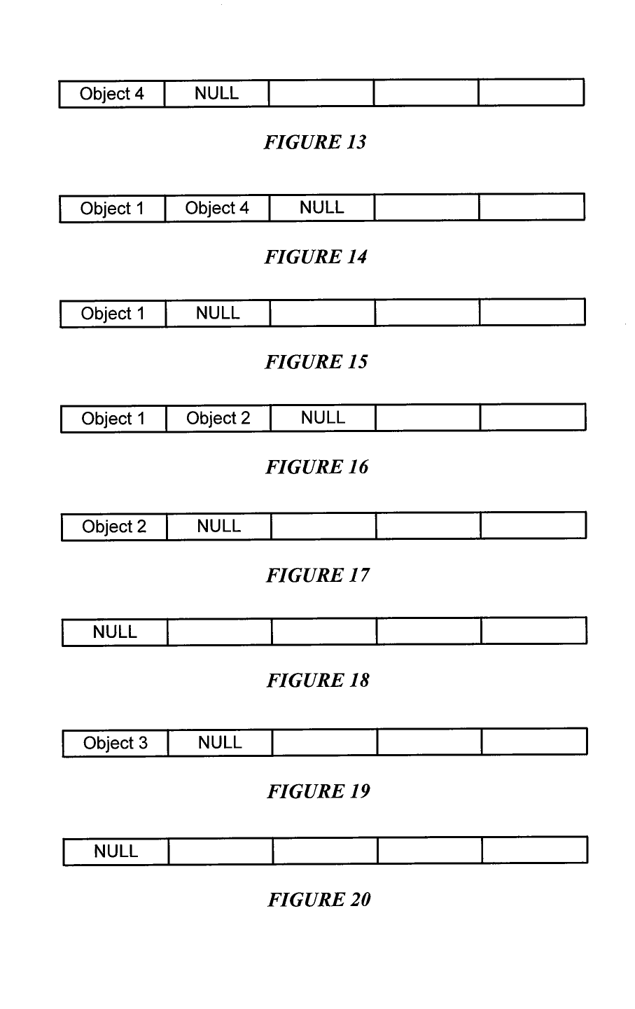

Continuing with the processing of the example image 600 of FIG. 6, at scanline 610 Y=200, Object 4 (608), having ObjectID=3, is first considered. An example object list 1300 is shown in FIG. 13 indicating the consideration of Object 4 (608). Thus, any objects having an ObjectID less than 3 will be rendered prior to the painting of Object 4 (608) scanline. Since the instruction is opRenderBandColor, the instruction is applicable to only the current scanline, i.e. it is not a trapezoid. Therefore, the band is rendered to the band buffer, and the object is not inserted into the object list. When scanline Y=201 is encountered containing Object 4 (608) (with ObjectID=3) with instruction opRenderTrapColor, there are still no objects populated in the object list. The scanline extent to be painted is then computed using x0, x1, dx0, dx1, lAdj, rAdj, llx and urx values within the data of the OpCode. The colors (i.e. C, M, Y, K) are set to the scanline graphics state. However, prior to changing the color in the graphics state, the current graphics state color is stored in a temporary variable, so that after rendering, this color can be reinstated. Since the OpCode is associated with a trapezoid, now Object 4 (608) will be inserted to the object list as shown in FIG. 13.

This same rendering will continue until the scanline at Y=800 is reached. At Y=800, Object 1 (602) (with ObjectID=0) is encountered. However, since the instruction is opRenderBandColor (i.e. only applicable to the current scanline), Object 1 (602) has yet to be entered in to the object list. Inspection of the current object list reveals only Object 4 (608) (which has higher ObjectID than the current object, i.e. Object 1 (602)) as the current entry. Therefore, Object 1 (602) scanline will be rendered prior to rendering the Object 4 (608) scanline. At Y=801, the opRenderTrapColor instruction for Object 1 (602) is encountered, hence Object 1 (602) is now added to the object list in the sorted order, as shown in FIG. 14.

The rendering then continues on both Object 1 (602) and Object 4 (608) until Y=1000 is encountered, at which stage, Object 4 (608) has been completed and the object list entry corresponding to Object 4 (608) is removed and added to a freelist, as will be appreciated by those skilled in the art. Thereafter, a suitable object list reflecting this removal is illustrated in FIG. 15.

Rendering then continues on Object 1 (602) until Y=2000 is encountered. Prior to rendering the band for Object 2 (604), the object list is inspected, which reveals that Object 1 (602) (an object having a lower ObjectID than the ObjectID of Object 2 (604)) exists in the object list. Therefore, in accordance with the system and method of the subject application, Object 1 (602) scanline is first rendered, prior to rendering the Object 2 (604) scanline resulting in the correct overlap of the objects 602 and 604. At Y=2001, Object 2 (604) is thereafter also incorporated into the object list as shown in FIG. 16.

The rendering then continues until scanline 610 of Y=2600, whereupon Object 1 (602) has been completed and removed from the object list. Only Object 2 (604) now remains in the object list as shown in FIG. 17. Rendering of Object 2 (604) continues until scanline 610 at Y=4000, whereupon Object 2 (604) has been completed and removed from the object list. No objects remain in the object list following the removal of Object 2 (604), which results in the object list of FIG. 18. With respect to the image 600 of FIG. 6, no new OpCode instructions are encountered until the scanline 610 at Y=5000. At this scanline 610, Object 3 (606) is encountered with an opRenderTrapColor instruction. Object 3 (606) is then included in the object list and scanline rendered. The object list at this stage is shown in FIG. 19.

The rendering then continues until the scanline at Y=5400, whereupon Object 3 (606) has been completed and removed from the object list. No additional objects remain in the object list, which list is illustrated in FIG. 20. Thereafter, the banding of the page 600 is complete with no additional pixels remaining to be rendered in accordance with the subject application.

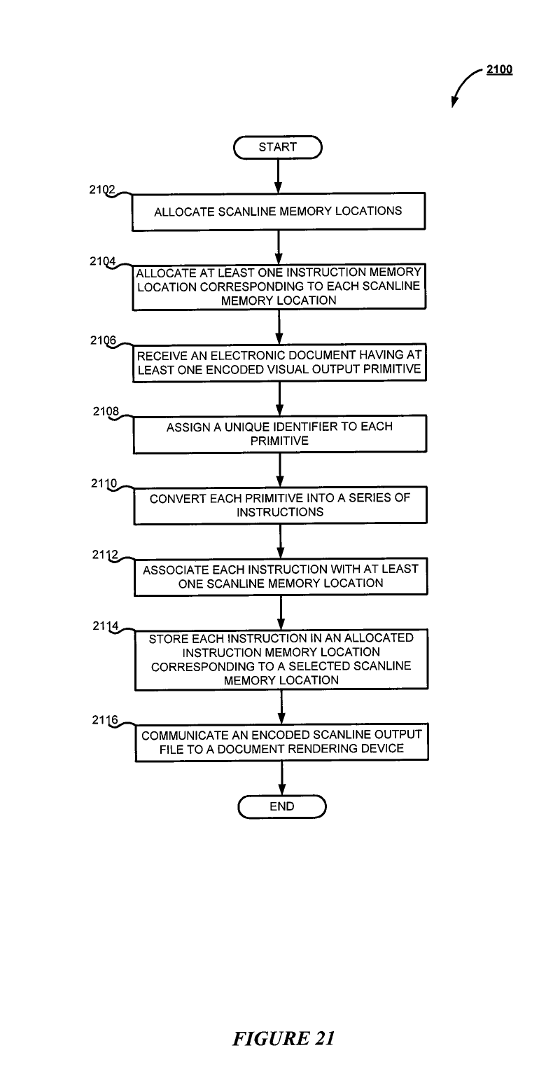

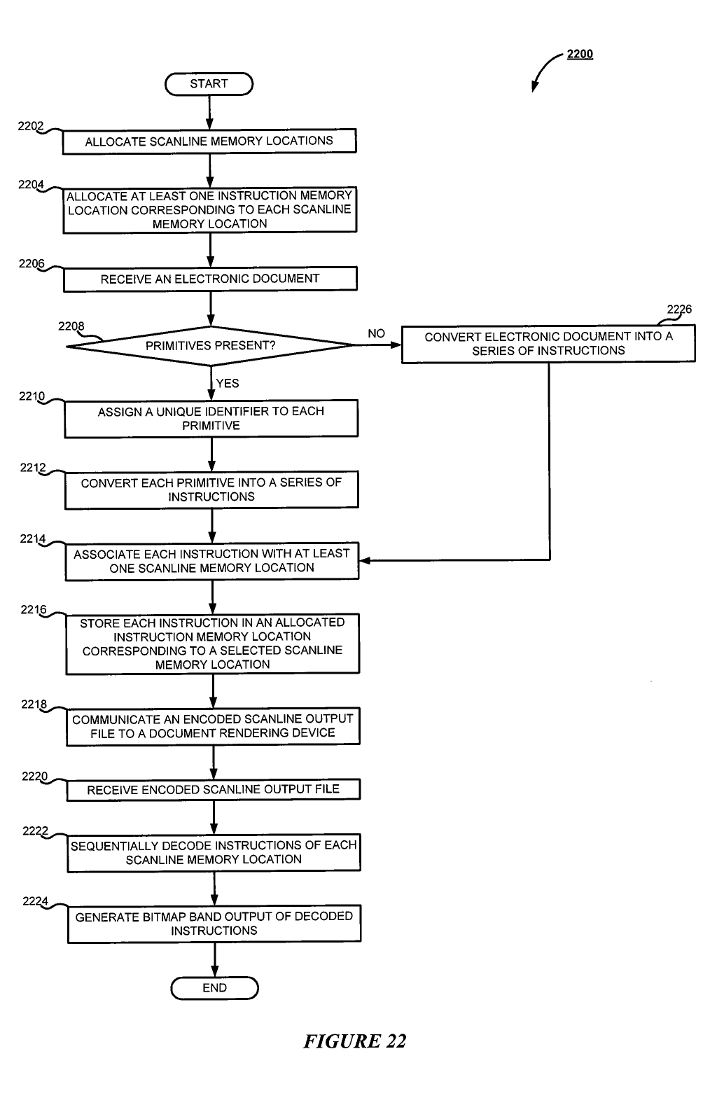

The skilled artisan will appreciate that the subject system 100 and components described above with respect to FIGS. 1-20 will be better understood in conjunction with the methodologies described hereinafter with respect to FIG. 21 and FIG. 22. Turning now to FIG. 21, there is shown a flowchart 2100 illustrating a method for document rendering in accordance with one embodiment of the subject application. Beginning at step 2102, scanline memory locations are allocated by an associated memory allocation unit, with each scanline memory location corresponding to a scanline of an electronic document to be rendered. Preferably, the memory allocation unit is hardware, software, or any suitable combination thereof associated with the controller 108 of the document rendering device 104. It will be appreciated by those skilled in the art that the methodology of FIG. 21 is capable of being implemented via operations of the user device 114 and the reference to the document rendering device 104 and associated hardware/software is for purposes of example only.

At step 2104, at least one instruction memory location is allocated by the memory allocation unit corresponding to each of the scanline memory locations. The controller 108 or other suitable component associated with the document rendering device 104 then receives, at step 2106, an electronic document that includes at least one encoded visual output primitive. In accordance with one embodiment of the subject application, the encoded visual output primitive corresponds to a point, line, polygon, or other similar graphics element of an image. Each primitive of the received electronic document is then assigned a unique identifier at step 2108. For example, each of the primitives, or objects, is assigned a unique ObjectID, which is used during rendering of the image as set forth above and explained in greater detail with respect to FIG. 22 below.

At step 2110, each primitive is converted into a series of instructions, or OpCodes which specify, for example and without limitation, color of the primitive, the opacity of the primitive, the pattern of the primitive, the pixel range associated with the primitive, raster operation code associated with the processing of the primitive, and the like. Each instruction is then associated, at step 2112, with at least one scanline memory location. Each instruction is then stored at step 2114 in an instruction memory location allocated by the memory allocation unit, e.g., the controller 108 or other suitable component associated with the document rendering device 104, and corresponding to a selected scanline memory location. Thereafter, at step 2116, an encoded scanline output file, inclusive of content of each instruction memory location corresponding to each scanline memory location, is communicated to an associated document rendering device 104 wherein each output primitive is rendered in accordance with a visual output priority corresponding to the unique identifiers of the primitives.

Referring now to FIG. 22, there is shown a flowchart 2200 illustrating a method for document rendering in accordance with one embodiment of the subject application. The document rendering methodology of FIG. 22 begins at step 2202, whereupon scanline memory locations are allocated by a memory allocation unit of the controller 108 or other suitable component associated with the document rendering device 104. In accordance with one embodiment of the subject application, each of the scanline memory locations corresponds to a scanline of a document that is to be rendered by the document rendering device 104. According to another embodiment of the subject application, the memory is allocated from system memory associated with the document rendering device 104, virtual memory accessed from the data storage device 110, or the like. At step 2204, the memory allocation unit, associated with the controller 108, or other suitable component associated with the document rendering device 104 allocates one or more instruction memory locations corresponding to each of the scanline memory locations.

Flow then proceeds to step 2206, whereupon an electronic document is received by the document rendering device 104 from the user device 114 via the computer network 102, from operations of the document rendering device 104, e.g., copying, scanning, facsimile transmission, portable storage media, or other suitable means of receiving electronic documents. A determination is then made at step 2208 whether encoded visual output primitives, or objects, are present in the received electronic document. The skilled artisan will appreciate that a visual output primitive corresponds to, for example and without limitation, points, lines, polygons, and the like. Suitable example visual output primitives include trapezoids, circles, triangles, squares, rectangles, spline curves, planes, and the like. Upon a determination at step 2208 that no primitive objects are present in the received electronic document, the data corresponding to the received electronic document is converted into a series of instructions at step 2226, with each instruction associated with at least one scanline memory location. The conversion of the electronic document data is explained in greater detail in U.S. patent application Ser. No. 11/376,797, as incorporated above. Operations then proceed to step 2214, whereupon each instruction is associated with at least one scanline memory location, as discussed in greater detail below.

Returning to step 2208, when it is determined that at least one encoded visual output primitive is present in the received electronic document, flow proceeds to step 2210. At step 2210, each of the encoded visual output primitives present are assigned a unique identifier. A suitable example of such assignment of a unique identifier is illustrated in FIGS. 6-20, discussed above. Following assignment of an identifier to each primitive, flow proceeds to step 2212, whereupon each of the primitives are converted into a series of instructions. Each instruction is then associated with at least one scanline memory location at step 2214. At step 2216, each of the instructions is stored in an allocated instruction memory location corresponding to a selected scanline memory location. In accordance with one embodiment of the subject application, each instruction specifies, for example and without limitation, color, opacity, pattern, pixel range, raster operation code, or the like. Suitable examples of such raster operation codes include, without limitation, text rendering, general band rendering, graphics rendering, batch rendering, caching, and the like.

At step 2218, an encoded scanline output file is then communicated to the document rendering device 104, for example and without limitation, the controller 108 to the appropriate component of the associated document rendering device 104, for further operations thereon. Preferably, a raster image processor, or other suitable component, associated with the document rendering device 104 is capable of performing the operations described by the series of instructions associated with the electronic document. The encoded scanline output file is then received by the document rendering device 104 at step 2220. Thus, when primitives are present in the received electronic document, the skilled artisan will appreciate that at least one scanline memory location includes instructions corresponding to each of the encoded visual output primitives. The document rendering device 104, or any suitable component thereof, then sequentially decodes the instructions from the scanline memory location at step 2222.

At step 2224, a bitmap band output is then generated by the document rendering device 104 or a suitable component thereof corresponding to decoded instructions of each scanline memory location, such that a visual output for overlapping primitives, if present, is selected in accordance with the identifiers associated with each primitive. The skilled artisan will appreciate that when primitives are present in the received electronic document, the sequential decoding corresponds to each of the plurality of encoded visual output primitives such that a decoded instruction generates a bitmap that selectively overwrites at least a portion of that associated with a prior decoded instruction. When visual output primitives are not present in the received electronic document, the document rendering device 104 generates bitmap band output of decoded instructions such that no overlap of such primitives are rendered.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A document rendering system comprising:
a memory allocation unit including,
scanline memory allocation means adapted for allocating a plurality of scanline memory locations, each scanline memory location corresponding to a scanline of a document to be rendered, and
instruction memory allocation means adapted for allocating at least one instruction memory location corresponding to each scanline memory location;
receiving means adapted for receiving an electronic document inclusive of at least one encoded visual output primitive;
means adapted for assigning a unique identifier to each received visual output primitive;
conversion means adapted for converting each visual output primitive of a received electronic document into a series of instructions;
association means adapted for associating each instruction with at least one scanline memory location;
storage means adapted for storing each instruction in an instruction memory location allocated by the memory allocation unit and corresponding to a selected scanline memory location; and
output means adapted for communicating an encoded scanline output file, inclusive of content of each instruction memory location corresponding to each scanline memory location, to an associated document rendering device, wherein each output primitive is rendered in accordance visual output priority corresponding to relative identifiers associated therewith.

2. The document rendering system of claim 1 further comprising:
means adapted for receiving the encoded scanline output file;
decoding means adapted for sequentially decoding instructions of each scanline memory location; and
means adapted for generating a bitmap band output corresponding to decoded instructions of each scanline memory location such that a visual output for overlapping primitives is selected in accordance with relative identifiers associated with each scanline memory location.

3. The document rendering system of claim 1, wherein each instruction specifies at least one of color, opacity, pattern, pixel range, and raster operation code.

4. The document rendering system of claim 1, wherein the receiving means includes means adapted for receiving the electronic document inclusive of a plurality of encoded visual output primitives, such that at least one scanline memory location includes instructions corresponding to each of the plurality of encoded visual output primitives.

5. The document rendering system of claim 4, wherein the decoding means decodes instructions from the at least one scanline memory location inclusive of instructions corresponding to each of the plurality of encoded visual output primitives, such that a decoded instruction generates a bitmap that selectively overwrites at least a portion of that associated with a prior decoded instruction.

6. The document rendering system of claim 5, wherein each instruction specifies at least one of color, opacity, pattern, pixel range, and raster operation code.

7. The document rendering system of claim 5 wherein at least one instruction includes a raster operation code inclusive of at least of text rendering, general band rendering, graphics rendering, batch rendering, and caching.

8. A document rendering method comprising the steps of:
allocating a plurality of scanline memory locations in an associated memory allocation unit, each scanline memory location corresponding to a scanline of a document to be rendered;
allocating at least one instruction memory location corresponding to each scanline memory location in the memory allocation unit;
receiving an electronic document inclusive of at least one encoded visual output primitive;
assigning a unique identifier to each received visual output primitive;
converting each visual output primitive of a received electronic document into a series of instructions;
associating each instruction with at least one scanline memory location;
storing each instruction in an instruction memory location allocated by the memory allocation unit and corresponding to a selected scanline memory location; and
communicating an encoded scanline output file, inclusive of content of each instruction memory location corresponding to each scanline memory location, to an associated document rendering device, wherein each output primitive is rendered in accordance visual output priority corresponding to relative identifiers associated therewith.

9. The document rendering method of claim 8 further comprising the steps of:
receiving the encoded scanline output file;
sequentially decoding instructions of each scanline memory location; and
generating a bitmap band output corresponding to decoded instructions of each scanline memory location such that a visual output for overlapping primitives is selected in accordance with relative identifiers associated with each scanline memory location.

10. The document rendering method of claim 8, wherein each instruction specifies at least one of color, opacity, pattern, pixel range, and raster operation code.

11. The document rendering method of claim 8, wherein the electronic document is received inclusive of a plurality of encoded visual output primitives, such that at least one scanline memory location includes instructions corresponding to each of the plurality of encoded visual output primitives.

12. The document rendering method of claim 11, wherein the instructions are sequentially decoded from the at least one scanline memory location inclusive of instructions corresponding to each of the plurality of encoded visual output primitives, such that a decoded instruction generates a bitmap that selectively overwrites at least a portion of that associated with a prior decoded instruction.

13. The document rendering method of claim 12, wherein each instruction specifies at least one of color, opacity, pattern, pixel range, and raster operation code.

14. The document rendering method of claim 12 wherein at least one instruction includes a raster operation code inclusive of at least of text rendering, general band rendering, graphics rendering, batch rendering, and caching.
